(19) United States
(12) Patent Application Publication
(10) Pub. No.: US 2004/0083632 A1
(43) Pub. Date: May 6, 2004

(54) Article with decorative liquid

(76) Inventor: Vincent K. Lee, Taipei (TW)

Correspondence Address: DENNISON, SCHULTZ & DOUGHERTY, 612 Crystal Square 4, 1745 Jefferson Davis Highway, Arlington, VA, 22202-3417, US

(21) Appl. No.: 10/285,407

(22) Filed: Nov. 1, 2002

(51) Int. Cl. G09F 3/00

(52) U.S. Cl. 40/326; 40/406

(57) ABSTRACT

An article, particularly a peripheral for a computer system, such as a card reader, a hub or a keypad, may be provided at a suitable position on a case thereof with a separated space to contain one or two decorative liquids, floating ornaments bearing advertising words and/or designs, miniature landscapes, etc., so that the separated space forms an integral part of the case of the article. The decorative liquids and the floating ornaments in the separated space create dynamic advertising effect without affecting the designed function of the article.

### BACKGROUND OF THE INVENTION

The present invention relates to an article with decorative liquid, and more particularly to an article being provided at a suitable position on a case thereof with a separated space for containing one or two decorative liquids and floating ornaments bearing advertising words and/or designs to achieve a dynamic advertising effect. The article may be a peripheral of a computer system, such as a card reader, a hub, or a keypad.

Most currently available peripherals for a computer system, such as card readers, hubs and keypads, and many other communication products, such as miniature phones, have differently designed cases to show a variety of appearances. Words and designs are frequently printed on the cases of these articles to provide an advertising effect. However, as being limited by the fixed structure of the cases, these advertising words and designs, either two or three dimensional, can only be shown in a static manner without any movement.

It is therefore desirable for the advertising words and designs on such articles to present in a dynamic manner to attract more consumers while give the articles unique appearances without affecting their designed functions.

### SUMMARY OF THE INVENTION

A primary object of the present invention is to provide an article with decorative liquid, so that floating ornaments bearing advertising words and designs could be disposed in the decorative liquid to create changeful views and dynamic advertising effect.

Another object of the present invention is to provide an article with decorative liquid to contain floating ornaments or fixed miniature landscapes, so that the article has a unique appearance to also serve as an attractive ornament when it is not in use.

To achieve the above and other objects, the article according to the present invention is provided at a suitable position on a case thereof with a separated space to contain one or two decorative liquids, floating ornaments bearing advertising words and/or designs, miniature landscapes, etc., so that the separated space forms an integral part of the case of the article. The decorative liquids and the floating ornaments in the separated space create a dynamic advertising effect without affecting the designed function of the article.

There are a variety of articles suitable for implementing the present invention, including different peripherals for a computer system, such as card readers, hubs and keypads, and many communication apparatus, such as miniature phones.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a card reader implementing the present invention;

FIG. 2 is an assembled perspective view of FIG. 1;

FIGS. 3 and 4 show other differently shaped card readers implementing the present invention;

FIGS. 5 and 6 show differently shaped hubs implementing the present invention;

FIG. 7 shows a numeric keypad implementing the present invention;

FIG. 8 shows a miniature phone implementing the present invention; and

FIG. 9 shows a hub having a mono-liquid ornament associated therewith to implement the present invention.

### DETAILED DESCRIPTION OF THE PREFERRED EMBODIMENTS

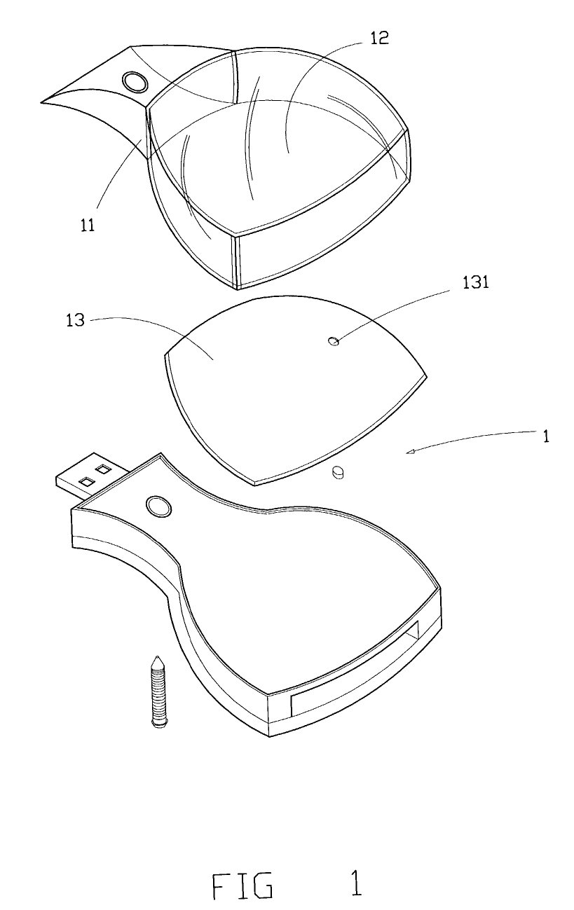

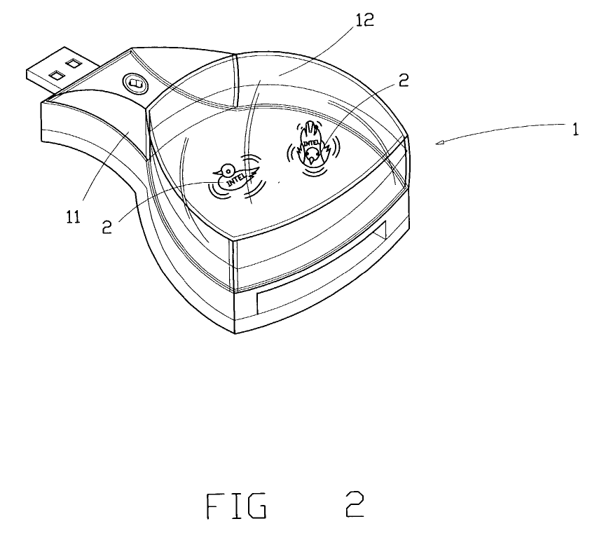

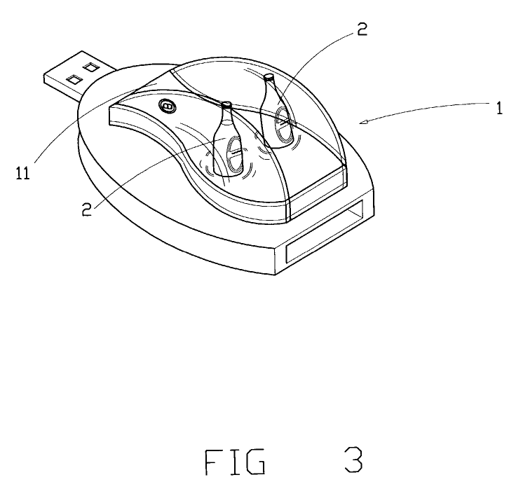

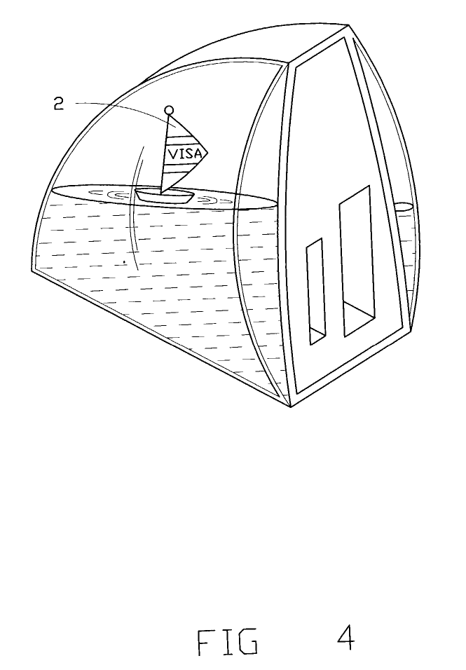

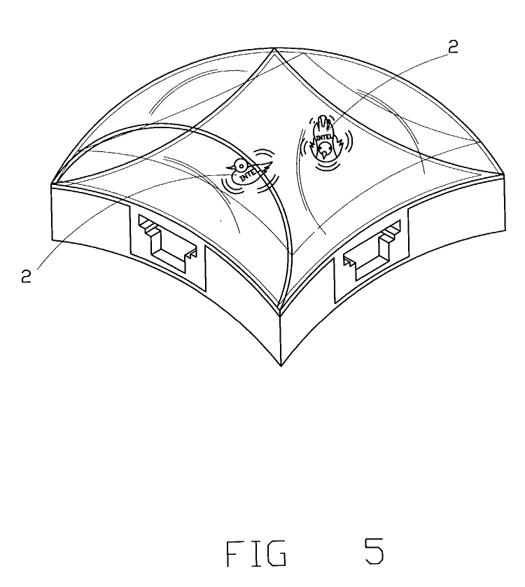

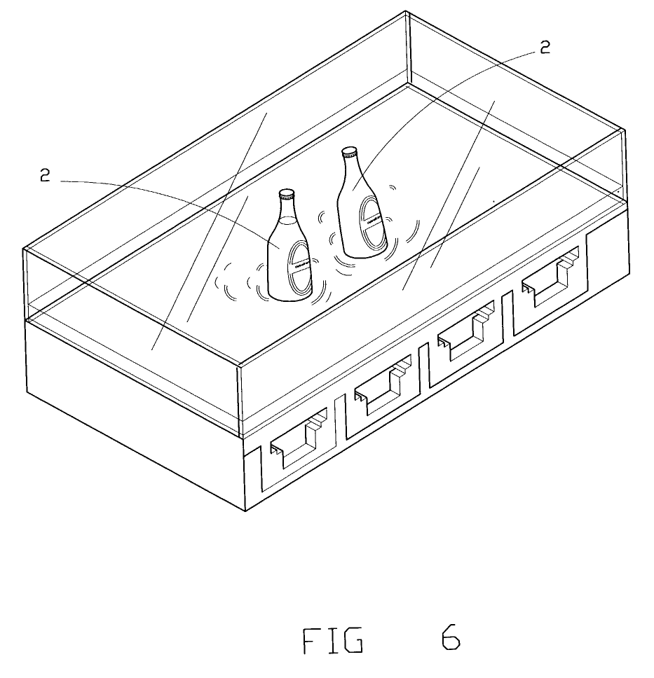

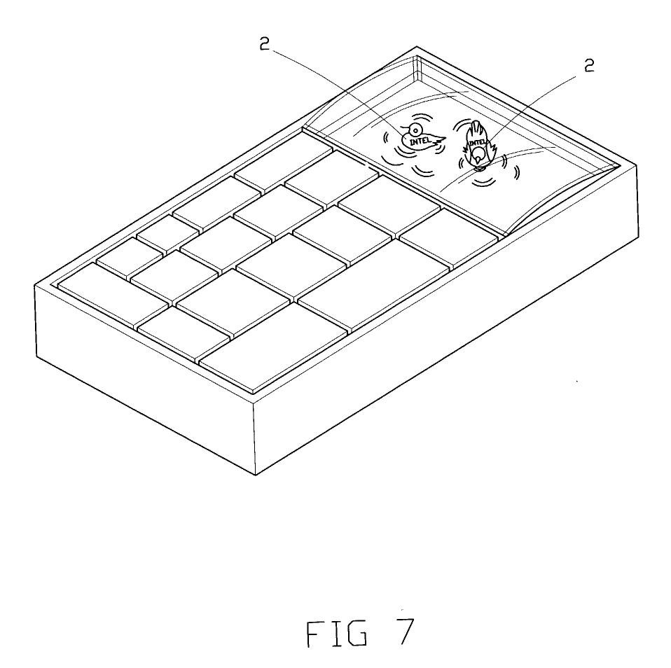

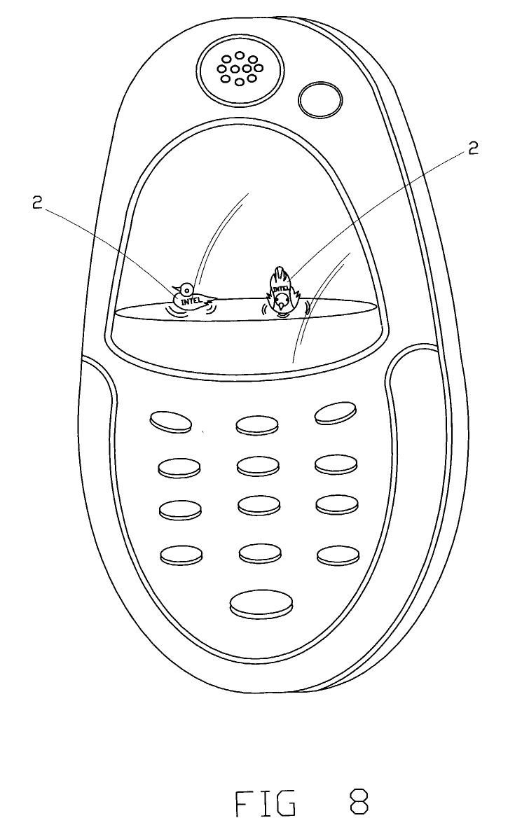

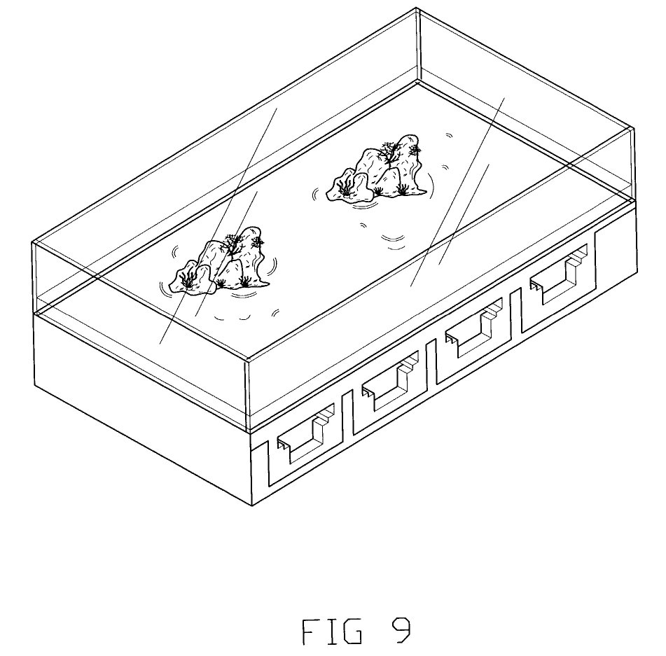

Please refer to FIGS. 1 and 2 that are exploded and assembled perspective views, respectively, of a card reader 1 implementing the present invention. As shown, the card reader 1 includes a transparent upper case 11 formed by integral injection molding. The upper case 11 defines an enclosed and open-bottomed hollow space 12 below it when it is injection-molded. The open bottom of the hollow space 12 can be closed with a lid 13. A through hole 131 is pre-formed on the lid 13 and can be sealed with a plug. Floating ornaments 2 having advertising words and/or designs printed thereon, such as ducks bearing the word “INTEL” as shown in FIG. 2, or Heineken bottles as shown in FIG. 3, maybe positioned in the hollow space 12 of the upper case 11 before the lid 13 is closed onto the open bottom of the space 12 to seal the same. Two different types of liquid are then filled into the space 12 via the through hole 131 on the lid 13 before the hole 131 is sealed with a plug. The upper case 11 with dual liquids and floating ornaments 2 filled therein is now completed and ready for assembling to the card reader 1. The floating ornaments 2 and the advertising words and/or designs provided thereon may be clearly seen from outside of the transparent upper case 11. The two different types of liquid enable the floating ornaments 2 to drift over a liquid surface in the space 12 and create dynamically changeful views in the upper case 11 to achieve an attractive advertising effect, making the card reader 1 unique and quite different from other commercially available card readers. FIGS. 3 and 4 show another two differently shaped card readers that also effectively implement the present invention. The present invention may be conveniently implemented by taking advantage of a very limited space on different articles, such as card readers, hubs, numeric keypads, etc. It is not necessarily to implement the present invention at the upper case 11 of these articles. Any other suitable location on different articles can be utilized to provide the dual-liquid ornament showing dynamic views and advertisements. For example, the present invention may be implemented on a hub as shown in FIGS. 5 and 6, a keypad as shown in FIG. 7, and a miniature phone as shown in FIG. 8. Alternatively, the hollow space 12 on the article implementing the present invention may be filled with only one type of liquid, and some miniature landscapes fixedly mounted in the space 12 may replace the floating ornaments 2, as shown in FIG. 9. When the article is moved or otherwise vibrated, the mono-liquid in the space 12 waves to create dynamically changeful views, too.

What is claimed is:

1. An article with decorative liquid, comprising an enclosed and transparent case portion, below which a hollow space is defined during molding of said case portion for containing at least one type of liquid, one or more floating ornaments bearing advertising words and/or designs, and/or other decorations, such as miniature landscapes.

2. The article with decorative liquid as claimed in claim 1, wherein said article is selected from the group consisting of card readers, hubs, numeric keypads, miniature phones, and other similar items.
